(19) United States
(12) Patent Application Publication
(10) Pub. No.: US 2022/0212951 A1
(43) Pub. Date: Jul. 7, 2022

(54) INFILTRATION SYSTEM MANAGEMENT

(71) Applicant: Geomatrix, LLC, Reston, VA (US)

(72) Inventors: David A. Potts, Lyme, CT (US); Daniel Borkowski, Meriden, CT (US)

(21) Appl. No.: 17/569,283

(22) Filed: Jan. 5, 2022

Related U.S. Application Data
(60) Provisional application No. 63/134,445, filed on Jan. 6, 2021.

(51) Int. Cl. C02F 1/00

(52) U.S. Cl. CPC C02F 1/008; C02F 1/001; C02F 2001/007; C02F 2209/02; C02F 2201/005; C02F 2209/42; C02F 2209/001; C02F 2209/003

(57) ABSTRACT

Infiltration system management and operation is provided using leading indicators. These leading indicators may be sensed at various locations and compared to a target value or range or other criteria when making adjustments to blower, vacuum, pump, or valve operation of an infiltration system. Other operational components or parameters may also be adjusted when considering one or more leading indicator. For instance, sacrificial carbon sources may also be added or replaced based on the status of a leading indicator and its comparison to a target value or range.

### RELATED APPLICATION

This application claims benefit of U.S. provisional patent application Ser. No. 63/134,445 filed Jan. 6, 2021 and entitled Infiltration System Management. The '445 provisional application is incorporated herein, in its entirety, by reference.

### TECHNICAL FIELD

Infiltration system operation, management, and remediation are provided and described. More specifically, the disclosure is directed to processes, systems, and apparatus that employ one or more leading indicators for operation, management, and/or remediation of infiltration systems and/or their constituent components.

### BACKGROUND

Water having various sources including septic wastewater, storm water, and process water (all of which may herein be collectively referred to as (“water”)) may be treated via an infiltration system of a water treatment system. Water treatment systems can vary in size and scope. They can be sized for treatment of large amounts of water from a municipality or other large cumulative systems for benefitting many residences, businesses, and industrial facilities serviced by the municipality. Infiltration systems and the water treatment system they can be a part of can also be designed and sized for single home residential use and small scale residential and commercial uses.

In the small-scale applications, a water treatment system will often include a treatment vessel that can receive water, allow for solids from the water to settle out as well as mitigate: Biological Oxygen Demand (BOD); Total Suspended Solids (TSS); nitrogen; Phosphorus; and bacteria and pathogens, among other constituents. Water treatment system will also often include an infiltration system downstream of a treatment vessel for receiving the water from the treatment vessel, treating the water, and for discharging the water back to the environment for further treatment and groundwater recharge. The infiltration system can include one or more infiltration fields comprised of any type of leaching, infiltration or treatment and dispersal system used for returning water back to the environment or used to treat filtration systems that treat water. These infiltration systems as well as other components of a water treatment system can become flow restricted with organic matter and/or biological microorganisms.

When moving through a water treatment system, water may pass through various filters and/or interfaces. These filters and/or interfaces may be located at various points of the treatment system including at a treatment vessel and at an infiltration system. These filters and/or interfaces may lose their passability and, thus, exhibit less hydraulic conductivity from a build-up of bioclogging matter, e.g., biological clogging matter and/or organic clogging matter. This bioclogging can serve to reduce or even stop the performance of filters or interfaces of a water treatment system, as well as the water treatment system in its entirety in severe bioclogging situations.

### BRIEF DESCRIPTION OF THE DRAWINGS

FIG. 1 provides features of infiltration system management processes using leading indicators as may be employed in some embodiments.

FIG. 2 provides features of infiltration system management processes using leading indicators that also may be employed in some embodiments.

FIG. 3 is a schematic of a water treatment system with an infiltration system, an infiltration system manager, treatment vessel, and other components as may be employed in some embodiments.

FIG. 4 is a schematic of a water treatment system with an infiltration system having two distribution laterals joined at a junction, an infiltration system manager, a treatment vessel, and other components as may be employed in some embodiments.

FIG. 5 is a side elevation cross-section of a treatment vessel with sensors as may be employed in some embodiments.

FIG. 6 is a schematic of an infiltration system manager as may be employed in some embodiments.

FIG. 7 is a side sectional view of an infiltration system comprising a leaching chamber as may be employed in embodiments.

FIG. 8 is a side sectional view of an infiltration system comprising a leaching chamber as may be employed in embodiments.

FIG. 9 is top view of a water treatment system with an infiltration system having three distribution laterals as may be employed in embodiments.

### DETAILED DESCRIPTION

This disclosure provides systems, processes, apparatus, and articles of manufacture that may provide enhanced treatment performance of water treatment systems comprising water infiltration systems. In embodiments, leading indicators may be measured or otherwise considered during management of water infiltration system operation. Air flow, water flow, carbon introduction, catalyst introduction, temperature change, as well as other operational aspects of an infiltration system, may each be singularly, in various combinations, or as a group: measured, modified, altered, added, subtracted, regulated, etc. based upon leading indicator measurements or other related considerations. These leading indicators may be measured and considered, or other considerations may be made, on a real-time automated basis for system operation as well as collected over time for subsequent adjustment of operational parameters of the infiltration system. Leading indicators may be automatically compared to various desired values and ranges and may be used to anticipate the subsequent operational status of an infiltration system and/or components of an infiltration system, such as an infiltration system or components thereof, such as leaching chambers or distribution laterals of an infiltration field.

Leading indicators of embodiments may be indicative of variables that have yet to impact the performance, status, flow rate, efficiency, nitrogen levels, Biochemical Oxygen Demand (BOD), Total Organic Carbon (TOC), Total Suspended Solids (TSS), nitrogen, pathogens and viruses or other operational parameter of an infiltration system. Examples of leading indicators for an infiltration system may include: Evapotranspiration, rainfall, snowfall, sleet or other precipitation (which may be collectively referred to as rainfall, rainwater, stormwater, or the like) at or around the infiltration system; influent flow rate/volume at the system entrance and/or flow rate/volume measured at various locations of the infiltration system along the treatment train (piping, storage, infiltration, pump, etc.) and/or at an output of the infiltration system; sensor status; pump status; pump speed; static pressure of air or water in the infiltration system measured at various locations of the system including vent locations, leach field input locations, blower outputs, blower inputs, etc.; ambient temperature at or around the infiltration system; effluent temperature at various locations along the treatment train and/or at an output of the infiltration system; separation tank temperature; influent wastewater temperature; leach field treatment media temperature; ambient temperature; surface ponding levels and/or ponding levels at various points in the system; and influent wastewater characteristics (e.g., nitrogen levels, BOD, TSS, TOC, pathogens and viruses, etc.)

Leading indicator sensors or measurement devices (LIS) may be of various types (e.g., precipitation sensor(s), nitrogen level sensor(s), BOD sensor(s), TSS sensor(s), TOC sensor(s), thermometer(s), static pressure sensor(s), etc.) and may be located at various locations within or outside of the infiltration system. As just one example, precipitation sensor(s) may be positioned above ground and at an elevation higher than an invert elevation of an infiltration field. LISs may be coupled by various means (e.g., physically, electronically, wired, or wirelessly, etc.) to an infiltration system manager (ISM), which may receive input from one or more LISs. The ISM may be computer-controlled or otherwise automated. The ISM may be configured to receive inputs from the LISs and to send control signals to operational components of the infiltration system. These control signals may provide instructions to activate, deactivate, speed, slow, open, close or make other operational changes of a valve, pump, blower, vacuum, heater, vibrator, aerator, carbon source provider (s), or other operational component of the infiltration system. Accordingly, one or more operational devices (e.g., blower(s), pump(s), air mover(s), valve(s), carbon source provider(s), heater(s), etc.) located at various locations within or outside the treatment train may be coupled by various means (e.g., physically, electronically, wired, or wirelessly, etc.) to an ISM, which may provide output, such as adjustment instructions, to one or more operational devices. The ISM may be computer-controlled or otherwise automated. Other alternatives are contemplated. For example, operational devices may be manually adjusted, or a combination of automated and manual adjustment may be employed. The ISM may also process signals and provide instructions for testing unused infiltration systems. This testing may be performed ahead of water flow into the unused infiltration system. An inactive field may be managed as described herein and may also be monitored for purposes of determining target values/ranges or other values/ranges for managing active infiltration fields. Thus, an ISM may be monitoring an infiltration field receiving water and/or not receiving water and may use observed values to make adjustments when managing an active or inactive infiltration field or other component of an infiltration system whether that component is receiving water or not receiving water.

With air traveling through soil, when the moisture content is at or below the infiltration system capacity, air flow pathways may be relatively well distributed and largely determined by the soil structure. However, when the moisture content in the soil adjacent to the infiltration system increases, as is the case during a rain event or other precipitation event, the result is that the water comes into contact with the air moving upwardly towards atmosphere. When this happens, the water movement downwardly is inhibited until the hydraulic head overcomes the pneumatic pressure. Comparably, when pneumatic pressure is greater than hydraulic head, bubbling within and above the soil results. This bubbling and associated agitation can result in the displacement of soil fines to the surface and distinct channels or pathways to the surface. Ultimately, even when the soil moisture content is at or below the system capacity, the airflow will increasingly flow through these short circuits/pathways to atmosphere. This results in a lower pressure differential and less uniform and dispersed air flow through the soil. When this occurs, the air comes into less contact with the water being infiltrated through the infiltration system, and less treatment and poorer performance results. The bubbling on the surface can also be an aesthetic issue, be mistaken for a gas leak, or have other non-performance impact.

The combination of rainwater and wastewater requiring treatment may become too great for a given airflow volume. This can diminish treatment. In some embodiments, control of the application of water requiring treatment to the infiltration system based on sensor input indicative of a leading indicator may be employed. In doing this, soil moisture content or other leach system status parameter may be optimized for improved efficient aeration, microbial interaction, etc. in order to increase treatment efficiencies.

During operation of some embodiments, when one or more leading indicator(s) is measured, the measured value may be compared, e.g., by an infiltration system manager (ISM) which may comprise a computer processor or the like, to a target value or range for the leading indicator(s) to determine whether the measured value(s) is at or within the target value or range. If the measured value(s) is not at or within the target value or range, one or more adjustment(s) of leach system management may be triggered, e.g., by the ISM. Exemplary adjustment(s) may comprise: adjusting wastewater flow to or from the leach field, adjusting blower speed and/or airflow to or from the leach field, adjusting status of leach field thermal management, adjusting leach field venting flow, and/or adjusting pumping flow to or from the leach field and/or parts of the leach field, and/or other adjustments. After adjustment(s) are made, additional measurements may be taken, and additional adjustments may be made, particularly if the leading indicator(s)' measured values continue to not to meet a target value or continue to fall outside a target range. In embodiments, once a target value or range is achieved, adjustment may be ceased or reversed for example, by the ISM. It is also contemplated that, instead of an ISM, another suitable measuring, comparing, and triggering means may be used, such as manual manipulation. Further, if an ISM is used, it may comprise means for a manual user to interface with, adjust, override, etc. the ISM.

Automated systems, processes, and articles of manufacturer are deemed suitable in embodiments. The complexity and timing of measurements and adjustments described herein make manual reading and use of leading indicators described herein to be implausible

In embodiments, oxygen levels, BOD, or other system variables can be monitored and based on these values certain volumes of wastewater can be applied, valve settings can be changed, pumps or blowers can be activated or deactivated as well as sped up or slowed down. If oxygen levels are above a desired value water flow can be decreased and vice versa other variables can be changed as well. Likewise, BOD and gallons of water can be measured and found to be suitable or not suitable for existing or expected flow to leach field. Table 1 shows variables that can be monitored and various actions that can be taken in embodiments.

During operation of some embodiments, when temperatures in and around the infiltration system are measured, higher ambient temperatures can be used to trigger system changes to increase airflow, increase water flow, as well as redirect airflow or water flow to a fallow leach field or other fallow (currently unused) portion of the infiltration system. These fields not receiving water or other components may have lower capacity than the previously designated field or another component. Conversely, lower ambient temperatures can be used to promote system changes to decrease airflow, decrease water flow, as well as redirect airflow or water flow to an inactive leach field or other inactive (not receiving water) portion of the infiltration system. These inactive fields or other components may have higher capacity than the previously designated field or another component. The increase or decrease in flow may be created by variable speed motors as well as bringing online additional pumps or blowers or by slowing or stopping one or more blowers or pumps in a treatment train.

Variable speed outputs may be employed in embodiments. These may include variable speed vacuums, variable speed blowers, variable speed dosing valves or other dosing devices, and automated variable speed carbon deployment devices and systems.

It is understood that warmer temperatures can allow more water to be treated, while colder temperatures can retard water treatment. As temperature increases, more air can be supplied to meet the associated increased oxygen demand. This is especially helpful for leaching systems under pavement.

In embodiments, infiltration system operation may be enhanced, maintained, remediated or rejuvenated by flowing air or other active gas through conduits or other components of the system. In embodiments, this air flow may be managed, controlled, modified, and/or activated/deactivated, with the use of leading indicators indicative of subsequent performance of the infiltration system and/or its constituent components.

In embodiments, air may be flowed through sand filters, media filters, cesspools, leaching chambers, perforated pipes in stone filled trenches, treatment vessels (such as leach pits, and septic tanks), infiltration systems, submerged treatment vessels, above-ground treatment vessels, and the like, and the adjacent soil where wastewater treatment takes place. In embodiments, conduits may be pressurized or evacuated with a partial vacuum, and auxiliary pipes may be buried in vicinity of the conduits. One or more air mover (vacuum, blower, etc.) may create a differential pressure sufficient to create a significant pressure differential with respect to atmosphere and to promote aeration and a desired physical or biochemical change in the soil adjacent the conduits. A typical pressure can be about 1-250 cm (about 0.5-100 inch) water column. If the soil is saturated, the air pressure may push water from the soil, as well as change the gas composition in the soil. The flow of water may be alternated with the flow of air. Different valve devices and piping configurations, e.g., settings, positions, orientations, operational status, etc., may be used to manage the desired flow of air and wastewater.

SoilAir® brand systems, covered by various patents, including U.S. Pat. Nos. 6,485,647, 6,726,401, 6,814,866, 6,887,383, 6,923,905, 6,959,882, 6,969,464, 7,157,011, 7,309,434, 7,374,670, 7,465,390, 7,744,759, D646,151, 8,617,390, and 8,834,727, have been utilized to enhance the performance of wastewater and stormwater treatment infiltration systems. SoilAir® brand systems are often utilized to rejuvenate failed systems, enhance treatment and improve hydraulic performance. Since air has thousands of times greater oxygen than water at the same temperature and pressure, SoilAir® branded systems are many times more effective than systems that directly aerate water.

During operation of some embodiments, when BOD is measured, if the BOD is considered higher than a target value or range, smaller doses of water and increased amounts of airflow may be provided. Conversely, if the BOD is considered lower than a target value or range, larger doses of water and decreased amounts of airflow may be provided.

During operation of some embodiments, when nitrogen is measured, if nitrogen is considered higher than a target value or range, changes may be made such that doses of wastewater may be directed or partially directed to an inactive infiltration field, doses of wastewater may be reduced in size, and/or air flow may be increased. A period of no water and no airflow may also be administered to promote anoxic conditions. Also, flow may be diverted through a carbon amended layer and/or carbon may be administered from another pump or tank. In other words, carbon sources may be injected into a treatment train when nitrogen is considered higher. If nitrogen is considered lower than a target value or range, doses of water may be increased in size and/or air flow may be decreased. A period of increased water and increased airflow may also be administered to retard anoxic conditions. Also, flow may be diverted through a carbon enriched layer in some embodiments when measuring or otherwise considering leading indicators.

Still further, during operation of some embodiments, when total suspended solids are measured, if low TSS as compared to a target value or range is detected, larger doses of wastewater may be pumped and/or larger volumes of air may be blown throughout the treatment train. Conversely, if high TSS as compared to a target value or range is detected, smaller doses of wastewater may be pumped and/or smaller volumes of air may be blown throughout the treatment train.

During operation of some embodiments, when high back pressures or static pressures, as compared to a target value or range are detected, water flow rates may be reduced while air flow rates may be increased. However, if it is raining, then air flow rates should preferably be reduced or stopped. When high back pressures or static pressures are detected, water flow rates may be decreased while air flow rates may be increased.

In some embodiments, when the leading indicators determine, such as increasing back pressure or static pressures, stronger oxidizers such as hydrogen peroxide and/or ozone can be introduced into the infiltration system to oxidize organic matter and increase the permeability of the soil or media.

During operation of some embodiments, when low BOD and high nitrogen are detected via leading indicator sensing or measurement, more carbon may be introduced. This introduction may be accomplished via introduction of methanol, charcoal, wood chips or via another carbon amendment formula or technique.

In some embodiments, a controller, sensor, and/or other management system component can monitor doses or volume per unit of time, and direct or redirect wastewater flow in anticipation of improved performance after redirection. These controllers, sensors, and/or other management system components may also monitor influent analytes or parameters including but not limited to nitrogen, phosphorus and other emerging contaminants of concern and optimize operations.

In water treatment systems of some embodiments, wastewater may be flowed from a primary wastewater processing unit, such as a treatment/processing vessel, through a conduit, and into an influence zone in the soil, and a significant pressure differential with respect to atmospheric pressure may be created, as gas, comprised of air or other biochemically active gas, flows between the conduit and the influence zone, in an amount effective for physical, biological and/or chemical change within the zone. The flow of active gas is preferably sufficient in amount to make the composition of gas within the influence zone effectively different from the composition that exists therewithin, in the absence of such flowing. Thus, if the leach field is functioning properly, embodiments may maintain or improve such proper functioning; and, if the system is failing, embodiments may restore part or all of the function. In some embodiments, air flows from a conduit, into and through the influence zone, in the same direction as the wastewater flows. In some embodiments, air flows from the influence zone and into the conduit. In some embodiments, an air mover such as a blower or vacuum pump establishes a pressure differential in the influence zone; this pressure differential may be significant.

In some embodiments, a blower pressurizes the system conduits relative to atmosphere, and air flows through the influence zone, the adjacent soil, and ultimately back to atmosphere. If the influence zone may be saturated, the pressure of air may cause the water in the influence zone to physically move away from the conduit and the zone may be de-saturated. When not fully saturated, the pressure of air flow may cause physical gas exchange, to make the composition of gas in the influence zone more near that of atmosphere. In some embodiments, air flows similarly, but from an unpressurized conduit to an auxiliary pipe which is buried in the soil and maintained at below atmospheric pressure. In some embodiments, an air mover lowers the pressure of gas in the conduit and air flows from atmosphere, through the soil and influence zone and into the conduit. In some embodiments, air flows from a pressurized auxiliary pipe buried in the soil adjacent the trench, and into a conduit vented to atmosphere. In some embodiments, air is introduced into the bottom of the infiltration trench by a pipe diffuser or by pipes that run lengthwise within the trench. In preferred practice, for a wastewater system embodying typical conventional soils, the differential air pressure between the conduit and atmosphere is at least about 1 cm (about 0.5 inches), preferably between 8-100 cm (about 3-40 inches) or more, water column, in order to produce a desired level of biochemically significant flow. In some embodiments, as air is flowed from a conduit into the influence zone, the pressure in the soil of the influence zone, a known distance from the inner boundary of the influence zone, can be desired to be a minimum water column height (e.g. x mm) as well as a preferred water column height that is higher than the minimum (e.g., y mm). In embodiments, the influence zone of a deteriorated system may be substantially anaerobic in character, and flowing of air or active gas preferably may cause a change so that it becomes predominantly aerobic. The quantity of air or other gas that is flowed into the influence zone can serve to provide oxygen substantially in excess of the stoichiometric quantity that is required for oxidation of the oxidizable constituents in the wastewater, as such constituents are typically determined by measurement of Oxygen Demand, in particular Biological Oxygen Demand (BOD). Optionally, a gas or liquid substance is added to the air to enhance biochemical activity.

In embodiments, air flow may be maintained continuously or intermittently, with or without simultaneous flow of wastewater by means of a control system. To ensure good functioning of a system, a low volume of air may be continuously flowed into the wastewater system, and the air may move through the influence zone contemporaneously with wastewater.

Embodiments may comprise a primary unit, such as a treatment vessel or other kind of reactor for primary processing of the wastewater, a leach system, for receiving wastewater effluent of the primary unit, where the leach system is comprised of a trench in the soil, a conduit within the trench, and soil adjacent the trench comprising an influence zone, and a means, such as a blower or vacuum pump, for producing a pressure differential between the conduit and the adjacent soil, where the pressure differential is preferably significant enough to effect a physical change, such as forcing water from the influence zone soil, or to effect biochemically significant change in the biochemistry of the influence zone. An infiltration system manager (ISM) and sensors may also be employed to monitor leading indicators and use these leading indicators for infiltration system management. Thus, sensors may detect any of the above identified leading indicators or others consistent with the teachings of this disclosure, and may be used by an ISM to instruct valve positioning, pump operation, blower operation, alert signals, status signals, and other operational control and/or feedback.

In some embodiments, there is a regulation means, such as a mechanical check valve or a water trap, in the pipeline of the wastewater system, so the effect of applied pressure or vacuum is limited to localized parts of the wastewater system. In one instance, there is a check valve in the distribution pipe, which runs from a septic tank or the like to a distribution box, or other distribution piping, and air pressure is injected at one or more selected points in the distribution piping or conduits. In another instance, there is a check valve in the wastewater line downstream of the stack vent and upstream of the point at which pressurized air is injected. In still other embodiments, pressure or vacuum is applied to the wastewater line running into the septic tank or other treatment vessel and a check or other valve is present upstream of the point of connection to the wastewater line of the blower or vacuum pump source of differential pressure.

In embodiments, a blower may be located in the stack vent of the system. Use of the regulation means may enable use of the system for processing wastewater simultaneously with use of air flow. A check valve bypass line, temporary storage reservoir and pump are optionally in the wastewater line to further aid in the objective of continuous use. The duration or periods during which air is flowed is optionally controlled by an ISM which may receive signals indicative of the composition or pressure of gas or liquid in vicinity of the influence zone or elsewhere in the wastewater system.

In embodiments, the system may be configured so that there is a void space above the soil surface of the influence zone, through which wastewater flows downwardly. For instance, the void might be the space within an arch shape chamber or the spaces amongst stones within a trench. Water may be first flowed in sufficient quantity and rate until it accumulates as a pond above the soil surface. The air pressure may be applied to the void, to give impetus to the natural flow of water. Then, the application of air pressure may be ceased, and either the water flow is resumed right away, or there is a period of quite time which may be substantially longer than the time of applying air pressure. The cycle may be repeated continuously. The process may save energy by decreasing the duration of air mover operation. Preferably, the amount of air or other gas provides a quantity of air per unit time of system operation, which quantity is many times greater, e.g., approximately 10 to 25 times or more, than the quantity which theoretically would satisfy the biological oxygen demand of the wastewater.

Embodiments may be effective in improving the operation of water treatment systems in a cost-effective way. Infiltration system performance and biochemistry may be improved and maintained through use of embodiments. Embodiments may be applied to existing installations and new installations and may be useful for rejuvenating the function of a system which has been either under-designed or over-used.

In embodiments, measurements of leading indicators may be compared to various desired results and system variable may then be modified or remain depending upon the results. In some instances, a leading indicator being above a desired value may promote increasing or decreasing in a variable of the infiltration system. For example, if BOD is above a desired value, leach field area may be increased by adding another field available for effluent flow. Likewise, if a ponding level in the leach field is too low, water flow rate to the leach field may be increased for a period time or until a measured ponding level is achieved. Comparisons between leading indicators and leaching system variables may involve target thresholds, such as being above or below a certain can warrant modification of a leaching system variable. Comparisons between leading indicators and leaching system variables may also involve linear and nonlinear comparators where leading indicators being above or below the comparator can warrant modification of a leaching system variable. Linear comparators may be defined by a linear equation while nonlinear comparators may be defined by a nonlinear equation. An exemplary linear comparator may be, for example, a percentage defining the comparator value while an exemplary nonlinear comparator may involve an exponential defining the comparator value.

Table 1 provides exemplary leading indicators that may be considered and different infiltration system variables that may be modified upon considering a single observation of the exemplary leading indicator as well as multiple observations. The multiple observations may be made sequentially, with certain prescribed gaps between sampling, randomly during a certain amount of time, and in other ways as well. Other variables may also be considered and modified in embodiments and these general recommendations may not be suitable for all fields or systems.

TABLE 1

| | | Airflow | | |
|---|---|---|---|---|
| Observed Leading | Infiltration | Rate | Dosing | Carbon |
| Indicator | Area Action | Action | Action | Supp. Action |
| Infiltration Rate | decreases | decrease | increase | increase |
| Incr. | | | | |
| Infiltration Rate | increases | increase | decrease | dec |
| Decr. | | | | |
| Precipitation Rate | increases | decrease | decrease | increase |
| Incr. | | | | |
| Precipitation Rate | decreases | increase | increase | decrease |
| Decr. | | | | |
| BOD Incr. | increases | increase | decrease | decrease |
| BOD Decr. | decreases | decrease | increase | increase |
| Ambient | decreases | increase | increase | increase |
| Temperature Incr. | | | | |
| Ambient | increases | decrease | decrease | decrease |
| Temperature Decr. | | | | |
| Influent | decreases | increase | increase | increase |
| Temperature Incr. | | | | |
| Influent | increases | decrease | decrease | decrease |
| Temperature Decr. | | | | |
| Influent Flow Incr. | increases | increase | increase | |
| Influent Flow Decr. | decreases | decrease | decrease | |
| Static Pressure of | increase | increase | increase | decrease |
| Airflow Incr. | | | | |
| Static Pressure of | decrease | decrease | decrease | increase |
| Airflow Decr. | | | | |
| Evapotranspiration | More et less | More et | More et | More et, less |
| | area | less | more vol | carbon |
| | | airflow | | |
| Nitrogen Incr. | increase | increase | decrease | increase |
| Nitrogen Decr. | decrease | decrease | increase | decrease |
| Total Suspended | increase | increase | decrease | decrease |
| Solids (TSS) Incr. | | | | |
| TSS Decr. | decrease | decrease | increase | increase |
| Total Org. Carbon. | increase | increase | increase | decrease |
| Incr. | | | | |
| Total Org. carbon. | decrease | decrease | decrease | increase |
| Decr. | | | | |
| Ponding Infiltration | increase | increase | increase | decrease |
| Field Water Level | | | | |
| Incr. | | | | |
| Ponding Infiltration | decrease | decrease | decrease | decrease |
| Field Water Level | | | | |
| Decr. | | | | |

Some embodiments may comprise using the processes, systems, articles of manufacture, or apparatus with or in stormwater and wastewater systems that comprise: a processing/treatment vessel; a distribution system; and an infiltration system comprising an infiltration field, monitoring ports, and carbon addition ports. Some embodiments may comprise using the processes, systems, articles of manufacture, or apparatus with or in infiltration systems comprising infiltration fields comprised of stone, sand, hollow structures, man-made materials and/or synthetic media including geotextiles. Some embodiments may comprise using the processes, systems, articles of manufacture, or apparatus with or in infiltration systems installed directly in native or imported soils. Some embodiments may comprise using the processes, systems, articles of manufacture, or apparatus with or in stormwater or wastewater systems that include a secondary treatment vessel, such as but not limited to, a treatment unit. Some embodiments may comprise using the processes, systems, articles of manufacture, or apparatus with or in stormwater and wastewater infiltration field(s) with a surface area to void space ratio of approximately <0.5. Surface area to void space ratio may be calculated by various methods such as calculations based on of storage volumes or on calculations based on the dimensions of the infiltration field components. Some embodiments may comprise using the processes, systems, articles of manufacture, or apparatus with or in stormwater and wastewater infiltration field(s) with a surface area to void space ratio of >0.5. Surface area to void space ratio may be calculated by various methods such as calculations based on of storage volumes or on calculations based on the dimensions of the infiltration system components. Some embodiments may comprise using the processes, systems, articles of manufacture, or apparatus with or in infiltration systems that are surrounded by the following soil textures:
Sands: silt+(1.5*clay)<15%
Loamy sands: silt+1.5*clay >=15% and silt+2*clay <30%
Sandy loams: clay >=7% and clay <20% and sand >52% and silt+2*clay >=30% OR clay <7% and silt <50% and silt+2*clay >=30%)
Loam: clay >=7% and clay <27% and silt >=28% and silt <50% and sand <=52%
Silt Loam: silt >=50% and clay >=12% and clay <27% OR silt >=50% and silt <80% and clay <12%
Silt: silt >=80% and clay <12%
Sandy Clay Loam: clay >=20% and clay <35% and silt <28% and sand >45%
Clay Loam: clay >=27% and clay <40% and sand >20% and sand <=45%
Silty Clay Loam: clay >=27% and clay <40% and sand <=20%
Sandy Clay: clay >=35% and sand >45%
Silty Clay: clay >=40% and silt >=40%
Clay: clay >=40% and sand <=45% and silt <40%

Some embodiments may comprise using the processes, systems, articles of manufacture, or apparatus with or in stormwater and wastewater systems that have stone, cobbles, gravel, ledge, bedrock, or soil parent material as the native material surrounding the system. Some embodiments may comprise using the processes, systems, articles of manufacture, or apparatus with or in stormwater and wastewater systems that have engineered media, such as specified sand or gravel/stone, as the material surrounding the system. Some embodiments may comprise using the processes, systems, articles of manufacture, or apparatus with or in stormwater or wastewater systems that include passive remediation infrastructure including, but not limited to, a constructed wetland, sand filters, gravel filters, waste stabilizing pond/lagoon, collection basin, rain garden, retention/detention areas, vegetated or dry swales, or underground detention systems. Some embodiments may comprise using the processes, systems, articles of manufacture, or apparatus with or in stormwater or wastewater systems that include vegetation pollutant removal, such as, but not limited to, rain gardens, bioswales, and evapotranspiration systems driven by such species as Salix or Phragmites. Some embodiments may comprise using the processes, systems, articles of manufacture, or apparatus with or in stormwater and wastewater systems that are covered with sand, imported or native soil. Some embodiments may comprise using the processes, systems, articles of manufacture, or apparatus with or in stormwater and wastewater systems that are covered with permeable or impermeable asphalt/pavement. Some embodiments may comprise using the processes, systems, articles of manufacture, or apparatus with or in stormwater and wastewater systems that open to the atmosphere. Some embodiments may comprise using the processes, systems, articles of manufacture, or apparatus with or in stormwater and wastewater systems that are located above grade.

Some embodiments may comprise using the processes, systems, articles of manufacture, or apparatus with or in wastewater systems that serve single residences, multi-family residences, commercial businesses, public organizations/property, private organizations/property, government buildings, and any other situation where onsite wastewater treatment or storm water management is used.

Some embodiments may comprise using the processes, systems, articles of manufacture, or apparatus with or in community based onsite wastewater treatment systems and any soil or water-based treatment systems serving as intermediate or final treatment or dispersal for wastewater treatment plants.

Some embodiments may comprise using the processes, systems, articles of manufacture, or apparatus with or in systems that employ a geotextile fabric within and/or around the system. The geotextile fabric may stabilize the sediment during treatment to avoid soil stratification by particle size.

Embodiments may be employed when a system is restricted or failing to treat and disperse wastewater. Embodiments may be employed when a system is overloaded with wastewater/stormwater and/or organic matter, causing low levels of oxygen within an infiltration field (which may occur either or both because microbial decomposition of organic matter consumes oxygen and because the oxygen concentrations in water are many thousands of times lower than oxygen concentrations in air). These situations may occur when a system is heavily used, the infiltration system is relatively undersized, or if there is an addition of materials to the system that are noncompatible with treatment in the infiltration system. Embodiments may be employed when a system is operating normally, or close to normally, and it is desirable to inhibit or prevent restriction or failing.

Embodiments may include a water treatment system comprising a treatment vessel having a water inlet and a water outlet; an infiltration system positioned downstream of the water outlet and configured to receive water from the water outlet; a first leading indicator sensor (LIS) the LIS configured to sense at least one infiltration leading indicator (ILI); a blower, or a pump, or a valve, or a combination thereof fluidly coupled to the infiltration system; and an infiltration management system (IMS), the IMS configured to receive signals indicative of an infiltration leading indicator (ILI) from the first LIS, the IMS configured to determine whether received signals from the first LIS is above or below a target ILI value or are within or outside of a target ILI range, and to change the operational status of the blower or the pump or the position of the valve based upon the determination of whether received signals are above or below a target ILI value or are within or outside of a target ILI range.

Embodiments may also comprise a first LIS that is a precipitation sensor, and is configured such that the IMS maintains the change in the operational status of the blower or the pump or the position of the valve for a period of time until received signals from the first LIS indicates that a precipitation is within a target ILI range.

Embodiments may also comprise a first LIS that is an infiltration field ponding level sensor and is configured such that the IMS maintains the change in the operational status of at least the blower or the pump or the position of the valve for a period of time until received signals from the first LIS indicate that a ponding level of the infiltration field is below a target value.

Embodiments may also comprise an LIS that is a water analyte sensor is positioned and is configured to test one or more water analyte at the water inlet or the water outlet of a treatment vessel.

Embodiments may also comprise a first LIS that is an infiltration system moisture sensor and the IMS may be configured to maintain a change in the operational status of the blower or the pump or the position of the valve for a period of time until received signals from the first LIS indicate that an infiltration field of the infiltration system moisture values are within a target ILI range.

Embodiments may include an infiltration management system (IMS) comprising a microprocessor; and a main memory in electronic communication with the microprocessor, wherein the main memory stores instructions for the microprocessor, which when followed, instruct the microprocessor to receive input from one or more infiltration leading indicator sensor(s) (ILI) to compare input from the one or more ILI with an infiltration leading indicator target value or an infiltration leading indicator target range, and to provide operational instructions to at least an infiltration system blower or an infiltration system pump or an infiltration system valve to maintain its operational status or to change its operational status.

Embodiments may comprise an IMS wherein the main memory stores further instructions for the microprocessor, which when followed, instruct the microprocessor to query an operator to provide the infiltration system leading indicator target value.

Embodiments may comprise an IMS wherein a main memory store further instructions for the microprocessor, which when followed, instruct the microprocessor to query an operator to provide the infiltration system leading indicator target range.

Embodiments may comprise an IMS wherein a microprocessor is instructed to receive input from one or more infiltration leading indicator sensor(s) (ILI) indicative of infiltration field ponding or infiltration field moisture level.

Embodiments may comprise an IMS wherein a microprocessor is instructed to receive input from one or more infiltration leading indicator sensor(s) (ILI) indicative of infiltration field influent temperature or infiltration field influent temperature change.

Embodiments may comprise an IMS wherein a microprocessor is instructed to receive input from at least four different infiltration leading indicator sensors, a first ILI sensor configured to sense and provide signals indicative of precipitation, a second ILI sensor configured to sense and provide signals indicative of infiltration field ponding level, a third ILI sensor configured to sense and provide signals indicative of water analysis, and a fourth ILI sensor configured to sense and provide signals indicative of moisture presence.

Embodiments may include an infiltration management system (IMS) comprising a microprocessor; and a main memory in electronic communication with the microprocessor, wherein the main memory stores instructions for the microprocessor, which when followed, instruct the microprocessor to receive input from one or more infiltration leading indicator sensor(s) (ILI) to compare input from one or more ILI with an infiltration system leading indicator target value or an infiltration system leading indicator target range, and to provide operational instructions to at least an infiltration system blower or an infiltration field pump or an infiltration field valve to maintain its operational status or to change its operational status.

Embodiments may comprise an IMS wherein the main memory store instructions for a microprocessor, which when followed, instruct the microprocessor to query an operator to provide the infiltration leading indicator target value.

Embodiments may comprise an IMS wherein the main memory store instructions for a microprocessor, which when followed, instruct the microprocessor to query an operator to provide the infiltration system leading indicator target range.

Embodiments may comprise an IMS wherein a microprocessor is instructed to receive input from one or more infiltration leading indicator sensor(s) (ILI) indicative of infiltration system ponding or infiltration system moisture level.

Embodiments may comprise an IMS wherein a microprocessor is instructed to receive input from one or more infiltration leading indicator sensor(s) (ILI) indicative of infiltration system influent temperature or infiltration system influent temperature change.

Embodiments may comprise an IMS wherein a microprocessor is instructed to receive input from at least four different infiltration leading indicator sensors, a first ILI sensor configured to sense and provide signals indicative of precipitation, a second ILI sensor configured to sense and provide signals indicative of infiltration field ponding level, a third ILI sensor configured to sense and provide signals indicative of water analysis, and a fourth ILI sensor configured to sense and provide signals indicative of moisture presence.

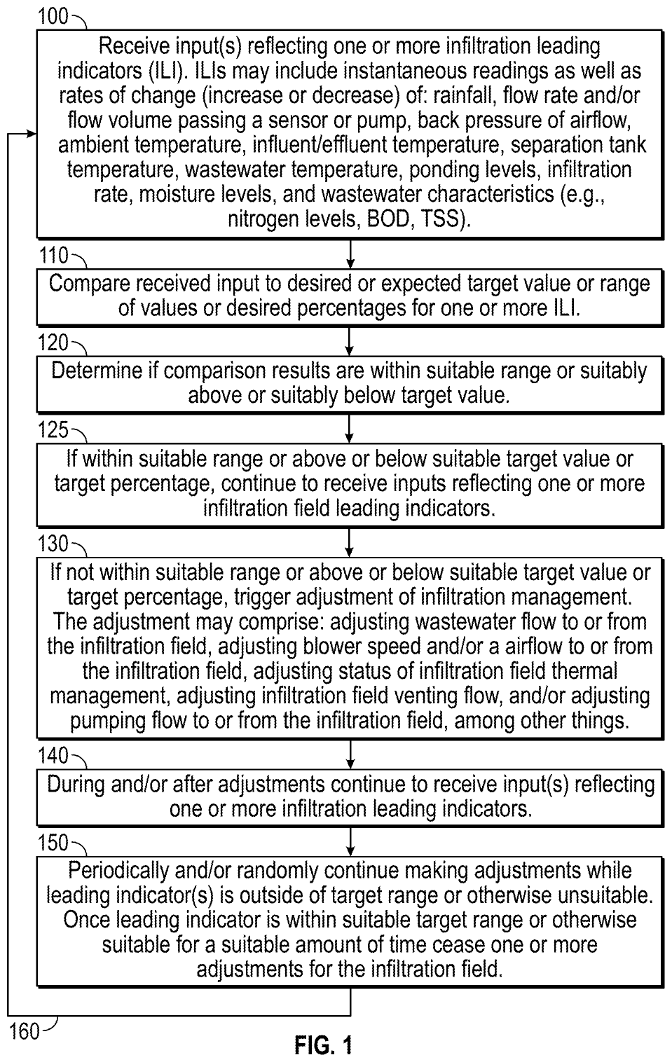

FIG. 1 provides features of infiltration system management processes using leading indicators as may be employed in some embodiments. As shown at 100, inputs may be received. These input(s) may reflect one or more infiltration (field or system) leading indicators (ILI). ILIs may include instantaneous readings as well as rates of change (increase or decrease) of various metrics, such as: rainfall, flow rate and/or flow volume passing a sensor or pump, back pressure of airflow, ambient temperature, influent/effluent temperature, separation tank temperature, wastewater temperature, ponding levels, infiltration rate, moisture levels, and waste water characteristics (e.g., nitrogen levels, BOD, TSS). As shown at 110, the received input(s) may be compared to desired or expected target value or range(s) of values or desired percentages for one or more ILI. As shown at 120, a comparison to determine whether results are within suitable range or suitably above or suitably below target value may take place. As shown at 125, if determination shows within suitable range or above or below suitable target value or target percentage, embodiments may continue to receive inputs reflecting one or more infiltration field leading indicators. As shown at 130, if determination shows not within suitable range or above or below suitable target value or target percentage, this can trigger adjustment of infiltration system management. The adjustment may comprise: adjusting wastewater flow to or from or within the infiltration system, adjusting blower speed and/or airflow to or from or within the infiltration system, adjusting status of infiltration system thermal management, adjusting infiltration system venting flow, and/or adjusting pumping flow to or from or within the infiltration system, among other things. As with other steps identified herein, an infiltration management system (IMS) may undertake the steps and processes identified herein. As shown at 140, during and/or after adjustments are undertaken, an IMS or other manager may continue to receive input(s) reflecting one or more infiltration leading indicators. As shown at 150, periodically and/or randomly IMS or other manager may continue making adjustments while leading indicator(s) are outside of target range or otherwise unsuitable. Once leading indicator is within suitable target range or otherwise suitable for a suitable amount of time IMS or other manager may cease one or more operational adjustments for the infiltration system. As shown at 160, the process may include returning to 100.

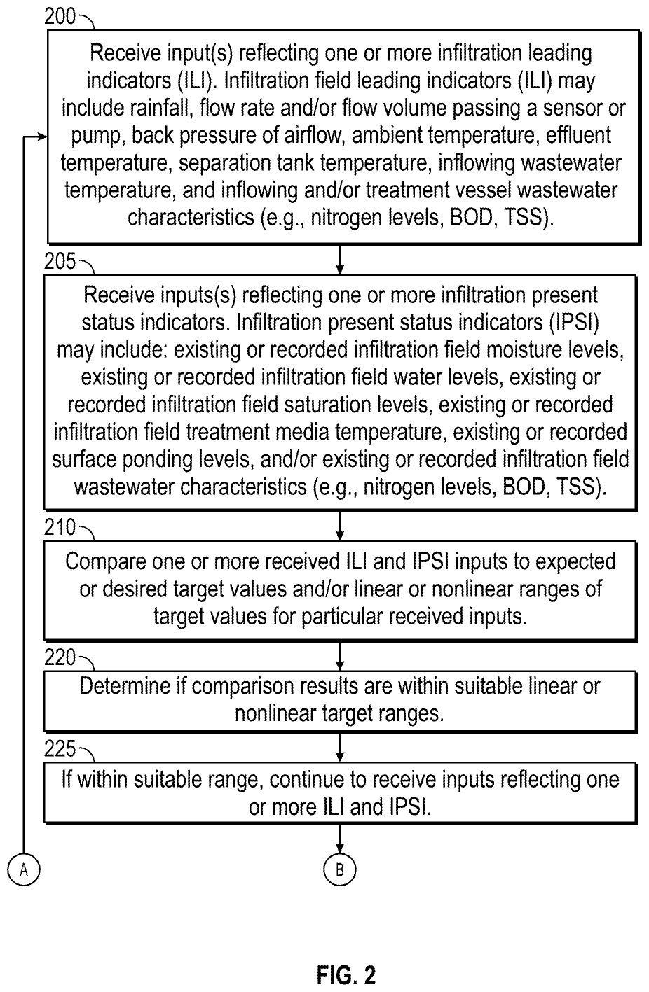

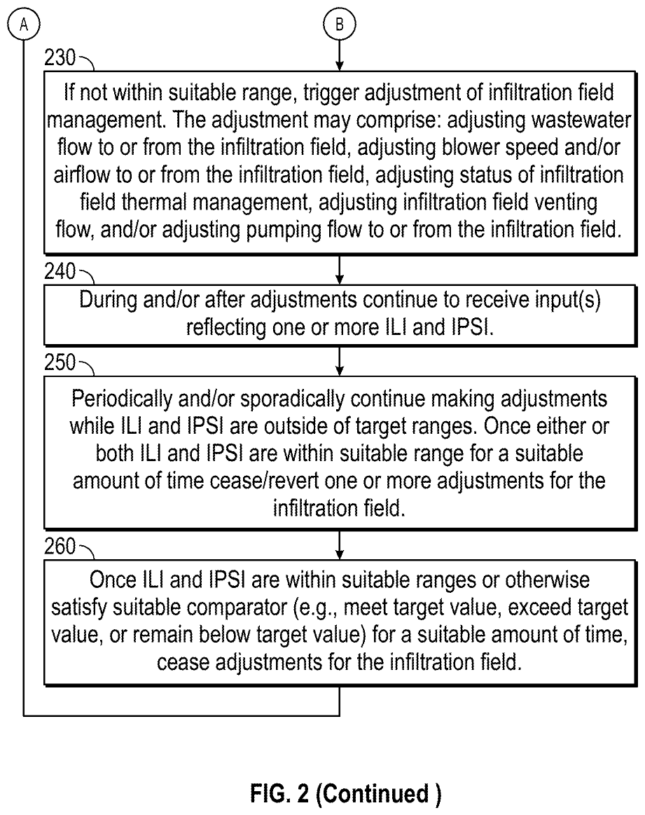

FIG. 2 provides features of infiltration system management processes using leading indicators that also may be employed in some embodiments. As shown at 200, embodiments can include receiving input(s) reflecting one or more infiltration (infiltration field or infiltration system) leading indicators (ILI). Infiltration leading indicators (ILI) may include rainfall, flow rate and/or flow volume passing a sensor or pump, back pressure of airflow, ambient temperature, effluent temperature, separation tank temperature, inflowing wastewater temperature, and inflowing and/or treatment vessel waste water characteristics (e.g., nitrogen levels, BOD, TSS). As shown at 205, embodiments may include receiving inputs(s) reflecting one or more infiltration field present status indicators. Infiltration (infiltration field or infiltration system) present status indicators (IPSI) may include existing or recorded infiltration field/system moisture levels, existing or recorded infiltration field/system water levels, existing or recorded infiltration field/system saturation levels, existing or recorded infiltration field/system treatment media temperature, existing or recorded surface ponding levels, and/or existing or recorded infiltration field/system waste water characteristics (e.g., e.g., nitrogen levels, BOD, TSS). These IPSI may be considered target values or preferred values in embodiments. As shown at 210, embodiments can include comparing one or more received ILI and IPSI inputs to expected or desired target values and/or linear or nonlinear ranges of target values for particular received inputs. As shown at 220, embodiments can include determining if comparison results are within suitable linear or nonlinear target ranges. As shown at 225, if within suitable range, embodiments may continue to receive inputs reflecting one or more ILI and IPSI. As shown at 230, if not within suitable range, embodiments may trigger adjustment of infiltration field/system management. The adjustment may comprise adjusting various components of an infiltration system, such as: adjusting wastewater flow to or from the infiltration field, adjusting blower speed and/or airflow to or from the infiltration field, adjusting status of infiltration field thermal management, adjusting infiltration field venting flow, and/or adjusting pumping flow to or from the infiltration field, among other things. In embodiments, as shown at 240, during and/or after adjustments, IMS or other managers may continue to receive input(s) reflecting one or more ILI and IPSI. As shown at 250, embodiments may periodically and/or sporadically continue making adjustments while ILI and IPSI are outside of target ranges. Once either or both ILI and IPSI are within suitable range for a suitable amount of time embodiments may cease/revert one or more operational adjustments being made for the infiltration system. As shown at 260, embodiments may, once ILI and IPSI are within suitable ranges or otherwise satisfy suitable comparator (e.g., meet target value, exceed target value, or remain below target value) for a suitable amount of time, cease adjustments for management of the infiltration system and return to 200.

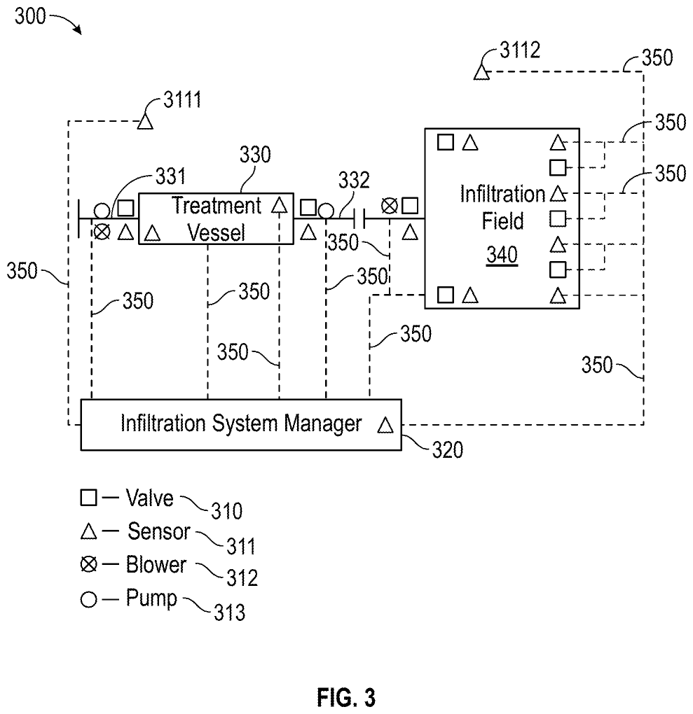

FIG. 3 is a schematic of a water treatment system with an infiltration system (including an infiltration field), an infiltration system manager, treatment vessel, and other components as may be employed in some embodiments. As can be seen, Infiltration System Manager (ISM) 320 is electrically connected via control/communication wiring 350 to sensors 311, valves 310, blowers 312 and pumps 313 of the water treatment system 300. The treatment vessel 330 is shown with an input conduit 331 and an output conduit 332. The input conduit 331 may receive wastewater from various sources. The output conduit 332 is shown to be in fluid communication with the infiltration field 340, which is part of an infiltration system. This infiltration field 340 may have various configurations that seek to infiltrate the received wastewater into its surrounding environment. This process of infiltration serves to treat the wastewater. Various valves 310 and sensors 311 are shown to reside in and around the infiltration field, the infiltration system, and the water treatment system 300. These valves and sensors are shown to be in communication with the infiltration system manager 320. The infiltration system manager is also shown to be in communication with other valves 310 and sensors of the waste water system 300 as well as with blower(s) 312 and pumps 313. While in use, the infiltration system manager 320 will receive and/or send communications to and from the blowers, sensors, pump, valves, etc. to use leading indicators for purposes of managing the infiltration field 340 or other components of the infiltration system of the wastewater system 300. The infiltration system manager may perform other functions as well. While one blower 312 is shown upstream of the treatment vessel and the infiltration field, other blowers may also be present in systems. These blowers can be employed to control air distribution and to manage air pressures (whether seeking to increase or decrease air pressures at various points of the wastewater system 300). The infiltration system manager 320 functionality may be performed by a single computing component as well as several physically separate modules. Additional sensors 311, valves 310, blowers 312, pumps 313, and other components may also be present in embodiments. And, these components may be in communication with an infiltration system manager 320 with wired and wireless communications and the infiltration system manager 320 may send/receive control signals to/from these components via wired and wireless methods. As shown in FIG. 3, remote sensors 3111-3112, as well as other components may be spaced apart from the treatment vessel and infiltration field 340 of waste water systems. These remote sensors 3111-3112 or other components may be used for environmental monitoring and/or environmental control or management. For example, ambient air temperature, rainfall, or other leading indicator may be sensed beyond the immediate border of the wastewater system and may be reported to the ISM 320 and may be used by the ISM 320 when managing the infiltration field 340. Similarly, blowers, pumps, or other active components, which are positioned beyond the immediate vicinity of the wastewater system 300 may be controlled by an ISM 320 when managing the infiltration field 340.

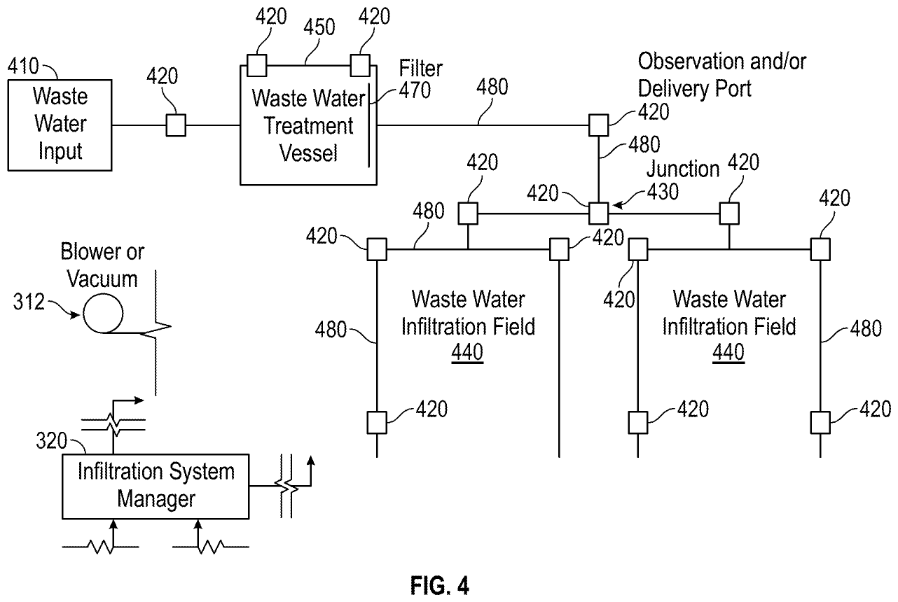

FIG. 4 is a schematic of a water treatment system with an infiltration system, an infiltration system manager, treatment vessel, and other components as may be employed in some embodiments. Water input 410 may be any of the various sources, including those identified herein. Multiple monitoring and/or delivery ports 420 are shown throughout. As can be seen, these ports 420 may be located in or around treatment vessel(s) 450, infiltration fields 440, and/or on distribution lines 480 connecting these components. These ports may be used for observation, sensor housing, for solution/reagent/stabilizer delivery, and for other purposes as well. Water treatment systems of embodiments may also employ a vacuum or blower 312 to promote air flow in and/or around the system. The infiltration system manager 320 is in communication with the various components of the water treatment system of FIG. 4. The infiltration system manager 320 may communicate with wired and wireless communication techniques to the various components of the water treatment system. These components include valve, sensors, and pumps, which are not shown in FIG. 4 but are shown in FIG. 3. FIG. 4 shows that the infiltration system can comprise two lateral infiltration fields joined at a junction.

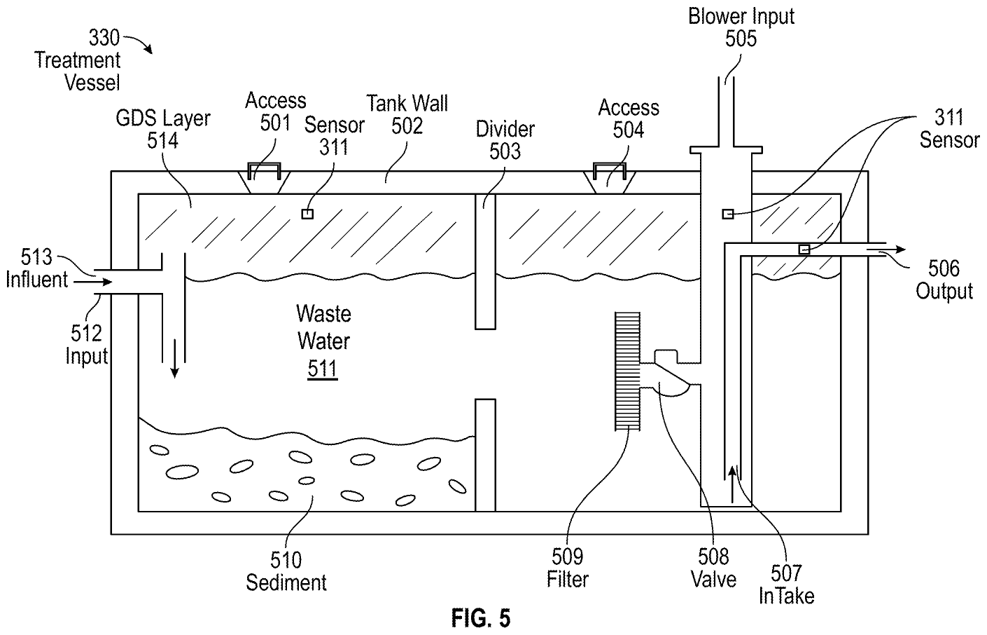

FIG. 5 is a side elevation cross-section of a treatment vessel with sensors as may be employed in some embodiments. The treatment vessel 330 has labelled access 501, sensors 311, vessel wall 502, divider 503, access 504, blower input 505, effluent output 506, intake 507, valve 508, filter 509, sediment 510, wastewater 511, input 512, influent 513, and gas layer 514. The sensors, as well as the valve, may be in communication with an infiltration system manager and may be operated from commands made by the infiltration system manager.

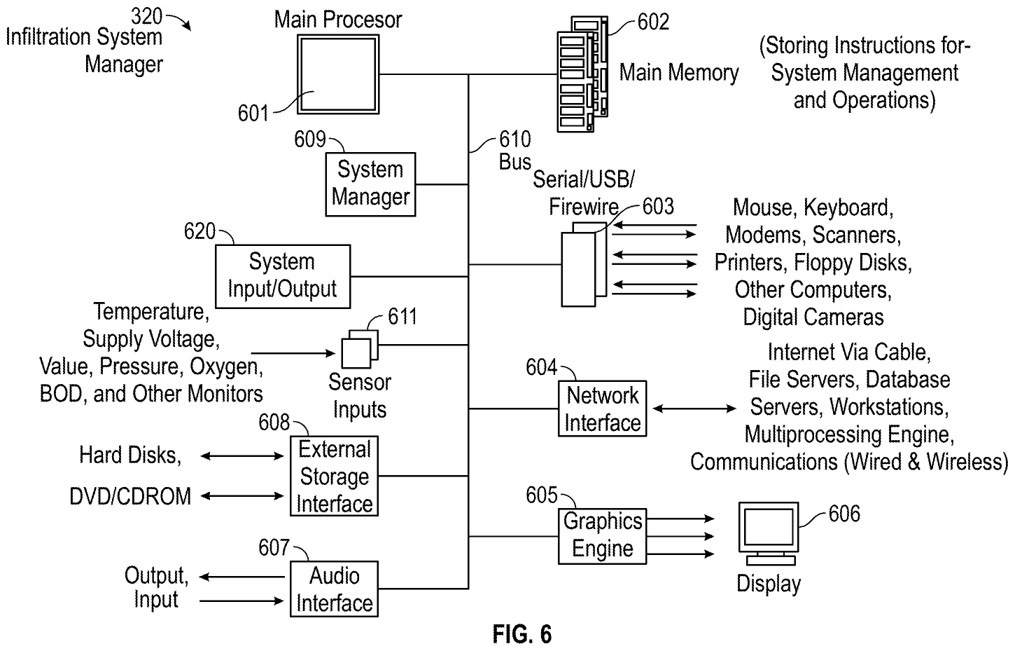

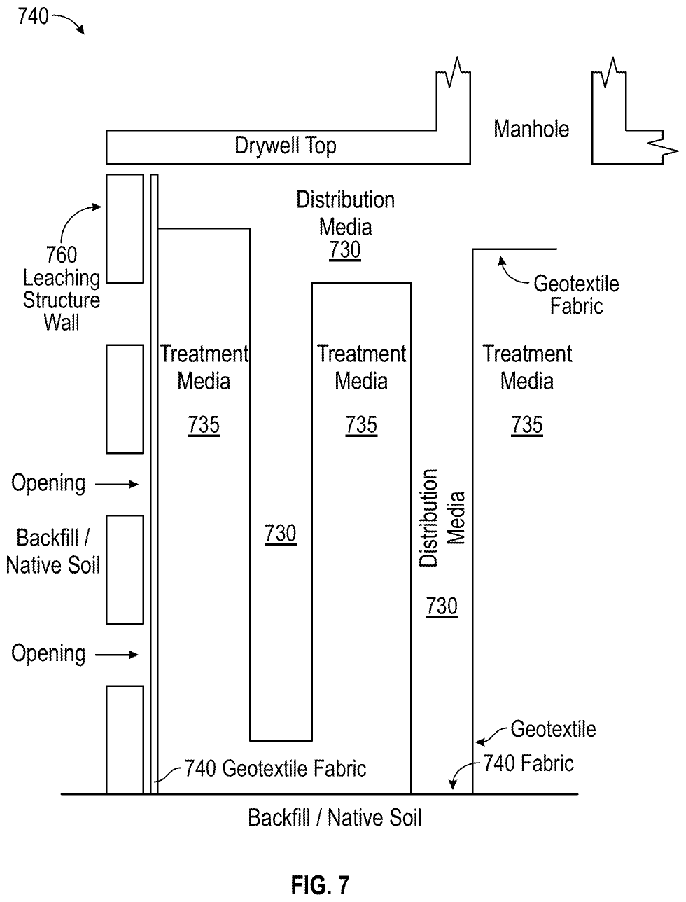

FIG. 6 is a schematic of an infiltration system manager 320 as may be employed in some embodiments. Labelled in FIG. 6 are main processor 601, main memory 602, serial/USB/firewire interface connections 603, network interface 604, graphic engine 605, display 606, audio interface 607, external storage interface 608, sensor inputs 611, system manager 609, system input/output 620, and bus 610. The sensor inputs may receive signals from sensors 311 identified in other figures and throughout the application. Output commands may be sent via the network interface 604 as well as system input/output 620. In operation, the main processor may receive instructions from the main memory and/or the external storage interface or other input source and may use these instructions to carry out one or more of the processes identified herein. Thus, in embodiments, system manager 609 may be microprocessor that works in conjunction with the main processor to receive inputs from various sensors and consider these inputs as described herein. Control signals may be sent/received to/from various components in and around an infiltration field being managed via system input/output 620. Updates and feedback as well as interfaces may be carried out via the graphics engine 605 as well as the audio interface 60 and the serial/USB/firewire adapter 603 and system input/output. Signals and information can also be relayed via mobile phones. FIG. 7 is a side sectional view of an infiltration field 740 as may be employed in embodiments.

FIG. 7 shows a cut-away view of a section of an infiltration field 740 with leaching structure wall 760 as may be employed in embodiments. As can be seen, the wall of the infiltration field 740, which is a leaching structure, may have passages in embodiments that allow water to pass from within the structure to outside of the structure. These passages may be covered with geotextile fabric, such as a filter fabric, or another material. The infiltration field 740 may also have a top and manhole(s) for access. This top may be positioned during installation and, preferably, after the treatment media 735 and distribution media 730 have been placed in the structure. As can be seen, the treatment media 735 can be different heights and thicknesses within the drywell structure, and the treatment media may be bounded on some or all sides with material such as geotextile fabric 740. Likewise, the distribution media 730 may have different configurations (heights, thicknesses, etc.). In embodiments, infiltration fields may be bounded on some or all sides with materials such as geotextile materials and fabrics. FIG. 7 does not show a bottom on the infiltration field 740 but in some embodiments the leaching structure or other infiltration field may have a permeable or non-permeable bottom comprised of concrete or other material.

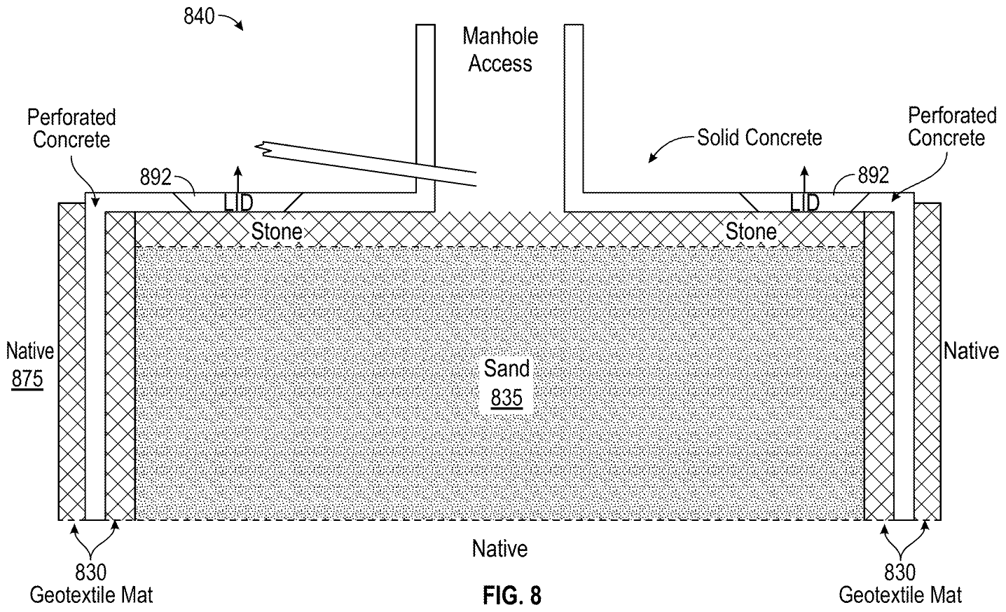

FIG. 8 is a side sectional view of an infiltration field as may be employed in embodiments. Labelled in FIG. 8 are an infiltration field 840, which is configured as a leaching structure, treatment media 835, and distribution media 830, as may be employed in embodiments. The distribution media of FIG. 8 comprises stone near the top of the leaching structure and geonet on the inside and outside of the walls of the leaching structure. Sand, the treatment media, is shown in the center of the leaching structure and above native material. The walls of the leaching structure are shown with perforated concrete and similar functioning materials, as may be employed in this or other embodiments. The geotextile mat and the stone, each distribution media, is shown in FIG. 8, along with a solid concrete top surface and perforated concrete side walls are shown. The geotextile mat distribution media is shown inside and outside the perforated concrete structural walls in this figure. Access lids 892 are also shown.

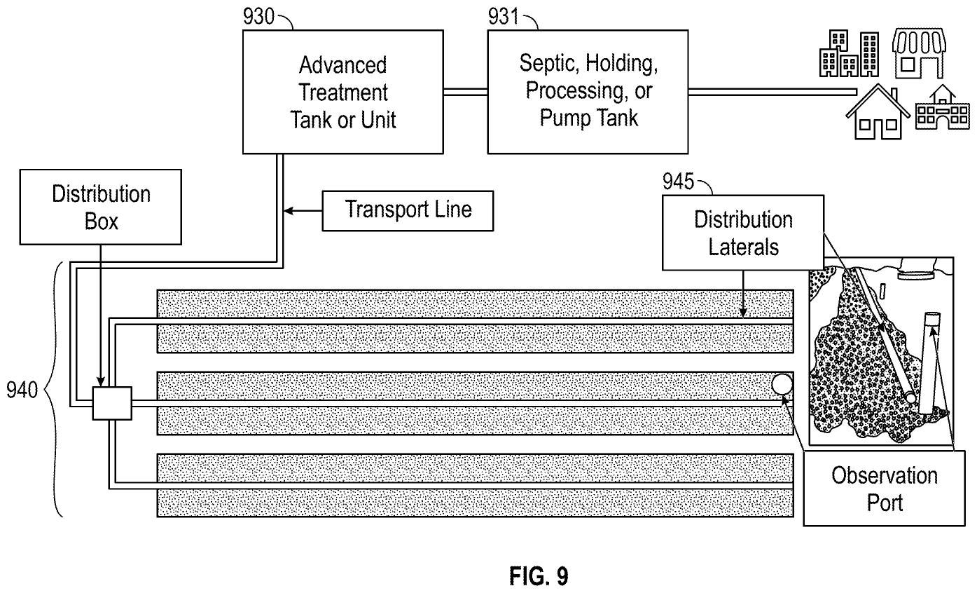

FIG. 9 is top view of a water treatment system with an infiltration system 940 having three infiltration field distribution laterals as may be employed in embodiments. The infiltration system 940 is shown with an input transport line, three leaching fields/distribution laterals 945, connecting piping, treatment media, and a distribution box. Two treatment vessels 930 and 931 are also labelled in FIG. 9. Leading indicators may be used to manage the infiltration system 940 as described herein.

The preceding detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Certain embodiments may be implemented as a computer process, a computing system or as an article of manufacture such as a computer program product of computer readable media. The computer program product may be a computer storage medium readable by a computer system and encoding computer program instructions for executing a computer process.

While embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention.

The terminology used herein is for the purpose of describing particular embodiments only and is not intended to be limiting of the invention. As used herein, the singular forms “a,” “an” and “the” are intended to include plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “about” or “approximately” in reference to a recited numeric value, including for example, whole numbers, fractions, and/or percentages, generally indicates that the recited numeric value encompasses a range of numerical values (e.g., +/−5% to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of ranges of values herein are merely intended to serve as a shorthand method of referring individually to each separate value falling within the range, unless otherwise indicated herein, and each separate value is incorporated into the specification as if it were individually recited herein.

“First,” “Second,” etc. As used herein, these terms are used as labels for nouns that they precede, and do not imply any type of ordering (e.g., spatial, temporal, logical, etc.). For example, reference to a “first” item does not necessarily imply that this item is the item in a sequence; instead, the term “first” is used to differentiate this item from another item (e.g., a “second” item).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

“Improve”—As used herein, improve is used to describe an increasing or maximizing effect. When a component or feature is described as improving an action, motion, or condition it may produce the desired result or outcome or future state completely. Additionally, “improve” can also refer to an increase of the outcome, performance, and/or effect which might otherwise occur. Accordingly, when a component, element, or feature is referred to as improving a result or state, it need not completely produce the desired result or state.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The corresponding structures, material, acts, and equivalents of any means or steps plus function elements in the claims are intended to include any structure, material or act for performing the function in combination with other claimed elements. The description of certain embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A water treatment system comprising:
a treatment vessel having a water inlet and a water outlet;
an infiltration system positioned downstream of the water outlet and configured to receive water from the water outlet;
a first leading indicator sensor (LIS) the LIS configured to sense at least one infiltration leading indicator (ILI);
a blower, or a pump, or a valve, or a combination thereof fluidly coupled to the infiltration system; and
an infiltration management system (IMS), the IMS configured to receive signals indicative of an infiltration leading indicator (ILI) from the first LIS, the IMS configured to determine whether received signals from the first LIS is above or below a target ILI value or are within or outside of a target ILI range, and to change the operational status of the blower or the pump or the position of the valve based upon the determination of whether received signals are above or below a target ILI value or are within or outside of a target ILI range.

2. The system of claim 1,
wherein the first LIS is a precipitation sensor, and
wherein the IMS maintains the change in the operational status of the blower or the pump or the position of the valve for a period of time until received signals from the first LIS indicates that a precipitation is within a target ILI range.

3. The system of claim 1,
wherein the first LIS is an infiltration field ponding level sensor, and
wherein the IMS maintains the change in the operational status of at least the blower or the pump or the position of the valve for a period of time until received signals from the first LIS indicate that a ponding level of the infiltration field is below a target value.

4. The system of claim 1 further comprising:
a second LIS, the second LIS being a water analyte sensor, and
wherein the second LIS is positioned and configured to test one or more water analyte at the water inlet or the water outlet of the treatment vessel.

5. The system of claim 1,
wherein the first LIS is an infiltration system moisture sensor, and
wherein the IMS maintains the change in the operational status of the blower or the pump or the position of the valve for a period of time until received signals from the first LIS indicate that an infiltration field of the infiltration system moisture values are within a target ILI range.

6. An infiltration management system (IMS) comprising:
a microprocessor; and
a main memory in electronic communication with the microprocessor,
wherein the main memory stores instructions for the microprocessor, which when followed, instruct the microprocessor to receive input from one or more infiltration leading indicator sensor(s) (ILI) to compare input from the one or more ILI with an infiltration leading indicator target value or an infiltration leading indicator target range, and to provide operational instructions to at least an infiltration system blower or an infiltration system pump or an infiltration system valve to maintain its operational status or to change its operational status.

7. The IMS of claim 6 wherein the main memory stores further instructions for the microprocessor, which when followed, instruct the microprocessor to query an operator to provide the infiltration system leading indicator target value.

8. The IMS of claim 6 wherein the main memory store further instructions for the microprocessor, which when followed, instruct the microprocessor to query an operator to provide the infiltration system leading indicator target range.

9. The IMS of claim 6 wherein the microprocessor is instructed to receive input from one or more infiltration leading indicator sensor(s) (ILI) indicative of infiltration field ponding or infiltration field moisture level.

10. The IMS of claim 6 wherein the microprocessor is instructed to receive input from one or more infiltration leading indicator sensor(s) (ILI) indicative of infiltration field influent temperature or infiltration field influent temperature change.

11. The IMS of claim 6 wherein the microprocessor is instructed to receive input from at least four different infiltration leading indicator sensors, a first ILI sensor configured to sense and provide signals indicative of precipitation, a second ILI sensor configured to sense and provide signals indicative of infiltration field ponding level, a third ILI sensor configured to sense and provide signals indicative of water analysis, and a fourth ILI sensor configured to sense and provide signals indicative of moisture presence.

12. An infiltration management system (IMS) comprising:
a microprocessor; and
a main memory in electronic communication with the microprocessor,
wherein the main memory stores instructions for the microprocessor, which when followed, instruct the microprocessor to receive input from one or more infiltration leading indicator sensor(s) (ILI) to compare input from one or more ILI with an infiltration system leading indicator target value or an infiltration system leading indicator target range, and to provide operational instructions to at least an infiltration system blower or an infiltration field pump or an infiltration field valve to maintain its operational status or to change its operational status.

13. The IMS of claim 12 wherein the main memory store further instructions for the microprocessor, which when followed, instruct the microprocessor to query an operator to provide the infiltration leading indicator target value.

14. The IMS of claim 12 wherein the main memory store further instructions for the microprocessor, which when followed, instruct the microprocessor to query an operator to provide the infiltration system leading indicator target range.

15. The IMS of claim 12 wherein the microprocessor is instructed to receive input from one or more infiltration leading indicator sensor(s) (ILI) indicative of infiltration system ponding or infiltration system moisture level.

16. The IMS of claim 12 wherein the microprocessor is instructed to receive input from one or more infiltration leading indicator sensor(s) (ILI) indicative of infiltration system influent temperature or infiltration system influent temperature change.

17. The IMS of claim 12 wherein the microprocessor is instructed to receive input from at least four different infiltration leading indicator sensors, a first ILI sensor configured to sense and provide signals indicative of precipitation, a second ILI sensor configured to sense and provide signals indicative of infiltration field ponding level, a third ILI sensor configured to sense and provide signals indicative of water analysis, and a fourth ILI sensor configured to sense and provide signals indicative of moisture presence.
